(19) United States
(12) Patent Application Publication
(10) Pub. No.: US 2025/0202139 A1
(43) Pub. Date: Jun. 19, 2025

(54) CONNECTOR

(71) Applicant: Yazaki Corporation, Tokyo (JP)

(72) Inventors: Masahide TSURU, Shizuoka (JP); Yukihiro KAWAMURA, Shizuoka (JP); Hideki MIZUNO, Shizuoka (JP); Kento TERAUCHI, Shizuoka (JP)

(73) Assignee: Yazaki Corporation, Tokyo (JP)

(21) Appl. No.: 18/975,275

(22) Filed: Dec. 10, 2024

(30) Foreign Application Priority Data
Dec. 18, 2023 (JP) 2023-213072

(51) Int. Cl. H01R 4/64; B60L 53/16; H01R 4/34; H01R 4/56

(52) U.S. Cl. CPC H01R 4/64; H01R 4/34; H01R 4/56; B60L 53/16; H01R 2201/26

(57) ABSTRACT

A connector includes: a routing material having a conductive plate-like conductor; a terminal connected to the plate-like conductor; and a housing for accommodating a connection portion that connects the plate-like conductor and the terminal. The connector further includes a conductive metal plate overlapped with the plate-like conductor positioned near the terminal.

### CROSS-REFERENCE TO RELATED APPLICATIONS

The present application is based on, and claims priority from the Japanese Patent Application No. 2023-213072, filed on Dec. 18, 2023, the entire contents of which are incorporated herein by reference.

### TECHNICAL FIELD

The present disclosure relates to a connector.

### BACKGROUND

Conventionally, in order to supply (charge) electric power to a battery pack mounted in a vehicle such as an electric vehicle and a plug-in hybrid vehicle from the outside of the vehicle, a charging system including a charging connector and a charging port (charging inlet) has been used (see, for example, JP 2023-517714 A). A high-power shield bus bar (routing material), which is used for charging and distributing electric power in the electric vehicle, is connected to the charging port disclosed in JP 2023-517714 A. The high-power shield bus bar sends electric power to the battery pack from the charging port, for example. The conductor of the high-power shield bus bar is made of a conductive material such as aluminum or copper.

### SUMMARY OF THE INVENTION

In vehicles, a large current flows through a plate-like conductor (bus bar) of the routing material that sends electric power due to electrification of the vehicles, and heat generated especially at the terminal to which the plate-like conductor is connected may increase due to such a large current. Therefore, when it is necessary to suppress a temperature increase at the terminal, it is generally necessary to increase the size of the whole routing material in thickness (increasing the cross-sectional area of the plate-like conductor over almost the whole length of the routing material) in order to increase the heat capacity of the plate-like conductor.

An object of the present disclosure is to provide a connector capable of suppressing a temperature increase at a terminal to which a plate-like conductor of a routing material is connected without causing an increase in the size and weight of the whole routing material.

A connection according to an embodiment includes: a routing material having a conductive plate-like conductor; a terminal connected to the plate-like conductor; a housing for accommodating a connection portion that connects the plate-like conductor and the terminal; and a conductive metal plate overlapped with the plate-like conductor positioned near the terminal.

The configuration described above makes it possible to provide a connector capable of suppressing a temperature increase at a terminal to which a plate-like conductor of a routing material is connected without causing an increase in the size and weight of the whole routing material.

### BRIEF DESCRIPTION OF DRAWINGS

FIG. 1 is a schematic exploded perspective view illustrating an example of a connector according to a present embodiment.

FIG. 2 is a schematic cross-sectional view illustrating an example of the connector according to the present embodiment.

FIG. 3 is a schematic perspective view illustrating a second bus bar overlapped with a first bus bar positioned near an inlet terminal.

### DETAILED DESCRIPTION OF THE INVENTION

Hereinafter, a connector according to a present embodiment will be described in detail with reference to the drawings. The dimensional ratios in the drawings are exaggerated for the sake of explanation and may differ from the actual ratios.

The connector according to the present embodiment can be applied to a charging connector used for charging a battery mounted in a vehicle, or a charging inlet disposed in a charging port of the vehicle.

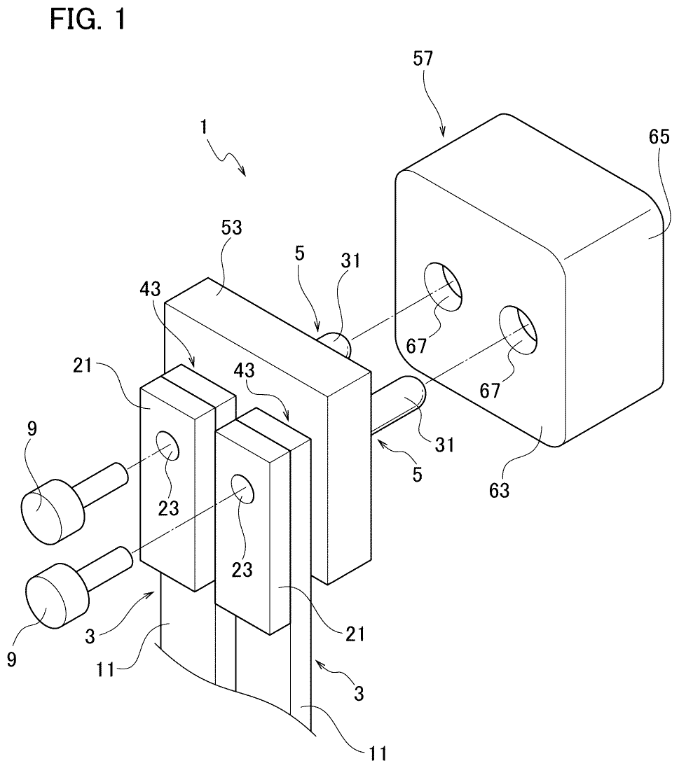

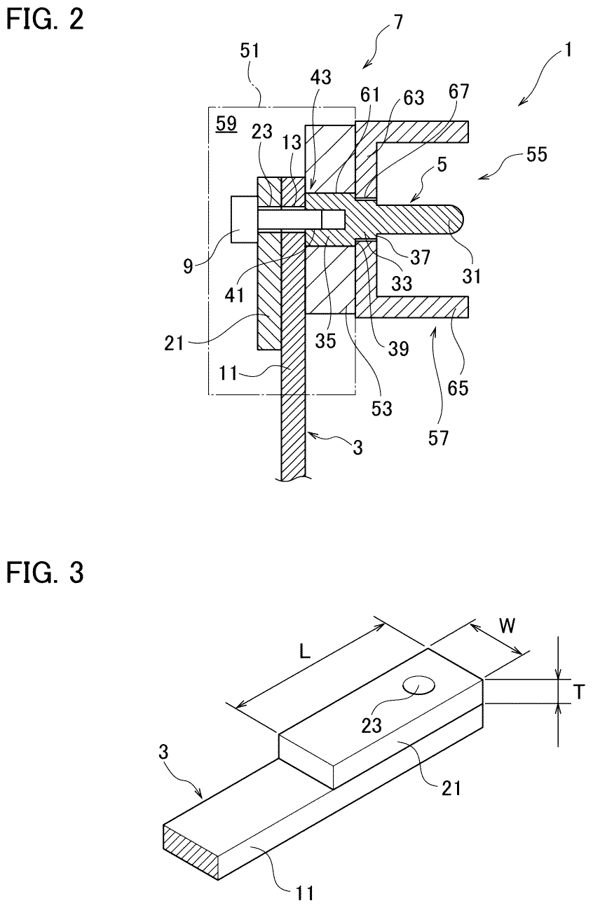

As illustrated in FIGS. 1 and 2, the connector (charging inlet 1) according to the present embodiment includes a routing material 3, an inlet terminal 5 as a terminal, and a housing 7.

A plurality of routing materials 3 (two in the present embodiment) are used and have a plate-like conductor (first bus bar 11) made of a conductive material. The first bus bar 11 is made of a metal material such as a copper-based material (copper or copper alloy) or an aluminum-based material (aluminum or aluminum alloy), for example. By using the first bus bar 11 made of copper or a copper alloy, since copper has a higher conductivity than aluminum, the size (cross-sectional area) of the first bus bar 11 can be reduced as compared with the case in which aluminum is used. In addition, a first bolt insertion hole 13 for inserting a bolt 9, which will be described later, is formed at the end portion of the first bus bar 11.

A plurality of inlet terminals 5 (two in the present embodiment) are used. The inlet terminal 5 is made of a metal material such as a copper-based material (copper or copper alloy) or an aluminum-based material (aluminum or aluminum alloy), for example.

In the present embodiment, the inlet terminal 5 has a small-diameter portion 31, a medium-diameter portion 33 positioned on the rear side of the small-diameter portion 31, and a large-diameter portion 35 positioned on the rear side of the medium-diameter portion 33. An annular first stepped portion 37 is formed at the boundary between the small-diameter portion 31 and the medium-diameter portion 33, and an annular second stepped portion 39 is formed at the boundary between the medium-diameter portion 33 and the large-diameter portion 35 (see FIG. 2). In addition, a bolt fastening hole 41 for fastening (screwing) the bolt 9 is formed on the rear end surface of the large-diameter portion 35 of the inlet terminal 5.

The first bus bar 11 of the routing material 3 is fastened (connected) to each of the inlet terminals 5 using a fastening member such as a bolt 9. The first bus bar 11 and the inlet terminal 5 are electrically connected to each other by being fastened using the bolts 9. The end portion of the first bus bar 11 and the large-diameter portion 35 of the inlet terminal 5 constitute a connection portion 43 that connects the first bus bar 11 and the inlet terminal 5.

The housing 7 includes an inner housing main body 51, a terminal holder 53 for holding the inlet terminal 5, and an outer housing main body 57 having an inlet frontage 55 formed to open so as to allow insertion of a charging connector (not illustrated). The housing 7 may be made of a synthetic resin material or a metal material.

The inner housing main body 51 has an accommodation space 59 for accommodating the connection portion 43 that connects the first bus bar 11 and the inlet terminal 5. The terminal holder 53 has a first terminal insertion hole 61 for inserting the large-diameter portion 35 of the inlet terminal 5. The outer housing main body 57 has a bottom wall 63 and a cylindrical side wall 65, and a second terminal insertion hole 67 for inserting the medium-diameter portion 33 of the inlet terminal 5 is formed in the bottom wall 63.

As illustrated in FIGS. 1 to 3, in order to increase the conductor cross-sectional area of the routing material 3 positioned near the inlet terminal 5, the second bus bar 21 as a conductive metal plate is overlapped with the first bus bar 11 positioned near the inlet terminal 5. A plurality of second bus bars 21 (two in the present embodiment) are used, and each of the second bus bars 21 is overlapped with the first bus bar 11 of the routing material 3. The second bus bar 21 is made of a metal material such as a copper-based material (copper or copper alloy) or an aluminum-based material (aluminum or aluminum alloy), for example. By using the second bus bar 21 made of copper or a copper alloy, since copper has a higher conductivity than aluminum, the size (cross-sectional area) of the second bus bar 21 can be reduced as compared with the case in which aluminum is used. In addition, a second bolt insertion hole 23 for inserting the bolt 9 is formed at the end portion of the second bus bar 21.

Note that since the first bus bar 11 and the second bus bar 21 of the routing material 3 have basically the same structure (shape), an end material that cannot be used as the first bus bar 11 can be used as the second bus bar 21.

Meanwhile, both the first bus bar 11 and the second bus bar 21 may be made of a copper-based material (copper or a copper alloy), and both the first bus bar 11 and the second bus bar 21 may be made of an aluminum-based material (aluminum or an aluminum alloy). In addition, one of the first bus bar 11 and the second bus bar 21 may be made of a copper-based material (copper or copper alloy), and the other of the first bus bar 11 and the second bus bar 21 may be made of an aluminum-based material (aluminum or aluminum alloy).

In the present embodiment, the second bus bar 21 partially overlapped with the first bus bar 11 is fastened to the inlet terminal 5 together with the first bus bar 11 using the bolts 9. However, the present embodiment is not limited to this configuration, and the second bus bar 21 may be fixed to the first bus bar 11 by being fastened using a fastening member such as a bolt at a position other than the position where the second bus bar 21 is fastened to the inlet terminal 5 together with the first bus bar 11 using the bolts 9. Further, the second bus bar 21 may be joined to the first bus bar 11 by welding or the like, or may be clamped together with the first bus bar 11 by using clamping members such as clips.

Further, in the present embodiment, the number of the second bus bar 21 partially overlapped with the first bus bar 11 is one. However, the present embodiment is not limited to this configuration, and the number of the second bus bar 21 partially overlapped with the first bus bar 11 may be two or more (plural number).

Further, in the present embodiment, a thickness T and a width W of the second bus bar 21 are equal to a thickness and a width of the first bus bar 11, respectively. However, the present embodiment is not limited to this configuration, and the thickness T and the width W of the second bus bar 21 may be different from the thickness and the width of the first bus bar 11, respectively. That is, the thickness T of the second bus bar 21 may be larger than the thickness of the first bus bar 11, and the thickness T of the second bus bar 21 may be smaller than the thickness of the first bus bar 11. In addition, the width W of the second bus bar 21 may be larger than the width of the first bus bar 11, and the width W of the second bus bar 21 may be smaller than the width of the first bus bar 11.

Furthermore, in the present embodiment, the second bus bar 21 is formed to have a length L that fits into the accommodation space 59 of the housing 7. That is, the second bus bar 21 is disposed so as to fit into the accommodation space 59 of the housing 7. The longer the length L of the second bus bar 21, the more advantageous it is to suppress a temperature increase at the inlet terminal 5. However, it is possible to sufficiently suppress a temperature increase at the inlet terminal 5 by increasing the conductor cross-sectional area of the routing material 3 positioned near the inlet terminal 5.

Thus, the connector (charging inlet 1) according to an aspect of the present embodiment includes the routing material 3 having the conductive plate-like conductor (first bus bar 11), and the terminal (inlet terminal 5) connected to the plate-like conductor (first bus bar 11). The connector (charging inlet 1) includes the housing 7 for accommodating the connection portion 43 that connects the plate-like conductor (first bus bar 11) and the terminal (inlet terminal 5). The connector (charging inlet 1) includes a conductive metal plate (second bus bar 21) overlapped with the plate-like conductor (first bus bar 11) positioned near the terminal (inlet terminal 5).

In the present embodiment, by overlapping the second bus bar 21 with the first bus bar 11 positioned near the inlet terminal 5, the conductor cross-sectional area of the routing material 3 positioned near the inlet terminal 5 can be increased, thereby making it possible to increase the heat capacity of the routing material 3 positioned near the inlet terminal 5. Therefore, due to the heat storage effect of the routing material 3, it is possible to effectively suppress a temperature increase at the inlet terminal 5 to which the first bus bar 11 of the routing material 3 is connected. In addition, by overlapping the second bus bar 21 with the first bus bar 11 positioned near the inlet terminal 5, it is possible to suppress an increase in the size and weight of the whole routing material 3.

As described above, the present embodiment makes it possible to provide a connector (charging inlet 1) capable of suppressing a temperature increase at the terminal (inlet terminal 5) to which the plate-like conductor (first bus bar 11) of the routing material 3 is connected without causing an increase in the size and weight of the whole routing material 3.

In the connector (charging inlet 1), the metal plate (second bus bar 21) may be disposed so as to fit into the housing 7 (accommodation space 59).

In the present embodiment, the second bus bar 21 is disposed so as to fit into the charging inlet 1. The longer the length L of the second bus bar 21, the more advantageous it is to suppress a temperature increase at the inlet terminal 5. However, it is possible to sufficiently suppress a temperature increase at the inlet terminal 5 by increasing the conductor cross-sectional area of the routing material 3 positioned near the inlet terminal 5.

In the connector (charging inlet 1), the metal plate (second bus bar 21) may be fastened to the terminal (inlet terminal 5) together with the plate-like conductor (first bus bar 11) using the fastening member (bolt 9).

By fastening the first bus bar 11 and the second bus bar 21 together to the inlet terminal 5, the first bus bar 11 and the second bus bar 21 come in contact with each other at a position near the inlet terminal 5, thereby making it possible to increase the conductor cross-sectional area of the routing material 3 positioned near the inlet terminal 5.

In the connector (charging inlet 1), the metal plate (second bus bar 21) may be made of copper or a copper alloy.

By using the second bus bar 21 made of copper or a copper alloy, since copper has a higher conductivity than aluminum, the size (cross-sectional area) of the second bus bar 21 can be reduced as compared with the case in which aluminum is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector, comprising:
a routing material having a conductive plate-like conductor;
a terminal connected to the plate-like conductor;
a housing for accommodating a connection portion that connects the plate-like conductor and the terminal; and
a conductive metal plate overlapped with the plate-like conductor positioned near the terminal.

2. The connector according to claim 1, wherein
the metal plate is disposed so as to fit into the housing.

3. The connector according to claim 1, wherein
the metal plate is fastened to the terminal together with the plate-like conductor using a fastening member.

4. The connector according to claim 1, wherein
the metal plate is made of copper or a copper alloy.
